(19) United States
(12) Patent Application Publication
(10) Pub. No.: US 2024/0314638 A1
(43) Pub. Date: Sep. 19, 2024

(54) METHOD FOR TRANSMITTING LINK ADAPTATION STATE INFORMATION IN TELECOMMUNICATION NETWORKS

(71) Applicant: Telefonaktiebolaget LM Ericsson (publ), Stockholm (SE)

(72) Inventors: Pablo Soldati, Solna (SE); Euhanna Ghadimi, Bromma (SE); Yu Wang, Solna (SE); Burak Demirel, Älvsjö (SE); Henrik Rydén, Stockholm (SE)

(21) Appl. No.: 18/274,740

(22) PCT Filed: Jan. 28, 2022
(86) PCT No.: PCT/EP2022/052066

§ 371 Date: Jul. 28, 2023

Related U.S. Application Data
(60) Provisional application No. 63/151,487, filed on Feb. 19, 2021.
(60) Provisional application No. 63/143,562, filed on Jan. 29, 2021.

(51) Int. Cl. H04W 28/18; H04L 1/00

(52) U.S. Cl. CPC H04W 28/18; H04L 1/0026

(57) ABSTRACT

Optimizing link adaptation for a communication session with a user device is disclosed herein. In one embodiment, a method performed by a network node of a telecommunications network to optimize link adaptation for a communication session with a user device comprises receiving a link adaptation state update message from a user device, wherein the link adaptation state update message comprises one or more link adaptation state information elements associated with a communication link between the network node and the user device. The method further comprises determining one or more link adaptation parameters for communicating with the user device based on the link adaptation state update message.

### RELATED APPLICATIONS

This application claims the benefit of provisional patent application Ser. No. 63/143,562, filed Jan. 29, 2021, and provisional patent application Ser. No. 63/151,487, filed Feb. 19, 2021.

### TECHNICAL FIELD

The present disclosure relates to link adaptation in a cellular communication system.

### BACKGROUND

Link adaptation, or adaptive modulation and coding (AMC), is a technique used in wireless communications systems, such as the Third Generation Partnership Project (3GPP) High Speed Downlink Packet Access (HSDPA), Long Term Evolution (LTE), or New Radio (NR), to dynamically adapt the transmission rate of a communication link to the time- and frequency-varying channel conditions. Modulation and Coding Schemes (MCS) effectively adapt the transmission rate by matching the modulation and coding parameters used for communication to the conditions of the radio link, such as propagation loss, channel strength, interference from other signals concurrently transmitted in the same radio resources, and the like. Link adaptation is a dynamic process that acts potentially as frequently as each transmission time interval (e.g., on a millisecond time-scale in the 3GPP LTE system), wherein the communication link between a radio node and a user device is scheduled for transmission.

Therefore, link adaptation algorithms require some form of Channel State Information (CSI) at the transmitter to improve rate of transmission, and/or to reduce bit or block error rates. CSI is typically reported by the receiver to the transmitter. In 3GPP LTE and NR systems, for instance, a user device can be configured to report, periodically or event-based, CSI measurement reports to the network that provide a measure of channel quality experienced by a user device. CSI reports may comprise, for instance, a channel quality indicator (CQI), rank indication (RI), and Precoding Matrix Index (PMI) for leveraging spatial diversity in multiple-input multiple-output (MIMO) transmissions. In a time-division duplex (TDD) system, it is often reasonable to assume channel reciprocity, (i.e., that the quality of the downlink channel from the transmitter (the network node) to the receiver (the user device) is approximately the same as the uplink channel quality). Therefore, the network node can use estimates of the uplink channel state derived from uplink sounding reference signals as a measure of the downlink channel state to perform the link adaptation process for the downlink communication.

In either case, the channel state information available at the transmitter may be not very accurate, or may degrade over time. For instance, channel state information derived from sounding reference signals is used by the transmitter until a new sounding reference signal is received. This implies that the latest channel state estimate becomes less and less reliable over time. This is referred to as channel aging. In the 3GPP LTE system, for instance, a user device can be configured to transmit sounding reference signals as frequently as every 2 ms (i.e., every other radio subframe) or as infrequently as 160 ms (i.e., every 16 radio frames). When the user device estimates the channel state information for the network node, the channel state report is received within a certain delay and the channel state measurements may have been prefiltered by the user device either over time, or over frequency or spatial domains (e.g., such as over different transmission beams in a multi-antenna system).

The mismatch between the channel state estimate available at the transmitter and the effective instantaneous channel state between the transmitter and the receiver may introduce uncertainty and errors in the selection of the transmission parameters, such as modulation order, MCS index, code rate, and the like, which may result in suboptimal performance. For instance, if the CSI is underestimated, the transmitter may configure a transmission with more conservative transmission parameter (e.g., a low modulation order). While this choice would make the transmission more robust to errors, less information would be transmitted in the allocated resource compared to the effective channel capacity, thereby resulting in reduced spectral efficiency and resource overutilization. On the other hand, if the channel quality is overestimated, the transmitter may configure more aggressive transmission parameters (e.g., a higher modulation order) and try to send more information than the channel capacity can carry, thereby increasing the probability of transmission failure. This would ultimately result in several retransmissions of the same information, thus reducing the user throughput as well as the network spectral efficiency.

Such mismatch can become severe in scenarios with rapidly varying channel conditions due to certain radio environment conditions, such as fast-moving user devices, sudden changes in traffic in neighboring cells, rapidly varying inter-cell interference, and the like. Therefore, link adaptation algorithms need to account for inaccurate channel state information to achieve high spectral efficiency in the data transmission.

Link adaptation algorithms attempt to optimally adapt the transmission data rate chosen for a link to the current channel and interference conditions of the link. FIG. 1 shows an example of how link adaptation can be implemented in a radio access network (RAN). A RAN typically relies on a discrete number of transmission rates that can be configured for a downlink transmission or an uplink transmission. Such discrete rate values are typically mapped to different combinations of modulation order and coding rate, also referred to as MCS values. Link adaptation algorithms adapt the communication rate of a radio link by selecting the most appropriate MCS value based on the latest information available about the state of the communication system as well as the state of the individual communication link for which the MCS value is selected.

State of the art of RAN systems, such as the 3GPP LTE and NR systems, rely on link adaptation strategies that aim to control the error decoding rate for each communication session over a radio link, also referred to as the Block Error Rate (BLER). A common strategy is to adapt the MCS selection, hence the data transmission rate, to maintain the average BLER for a communication session link below or equal to a certain value, hereafter referred to as “BLER target”. A typical BLER target choice is 10% BLER, that is, link adaptation aims at a 90% successful transmission rate at the first transmission attempt. To this end, the link adaptation algorithm executed by a network node exploits the CSI reported by the user device, such as the CQI, RI and PM, to derive an estimate of the signal to noise and interference ratio (SINR) experienced over the radio link by the user device, as illustrated in FIG. 1. Such initial estimate is then corrected by an offset value based on parameters computed as a function of the desired BLER target and the feedback from hybrid automatic repeat request (HARQ) process (i.e., positive and negative acknowledgement of previous transmissions over the link) to derive an effective SINR estimate which, in average, would yield a 10% BLER. The effective SINR estimate is ultimately used to select a MCS value for the next transmission attempt which can ensure a 10% BLER.

The BLER target used by link adaptation algorithms provides a proxy parameter for controlling the average quality of a communication session. Depending on the channel state of the communication link, however, an incorrect setting of the BLER target can result into an excessive usage of radio resources (e.g., if a too low BLER target is required from a communication link with poor channel quality, or in poor performance if a too high BLER target is configured for a link with very good channel performance).

### SUMMARY

Methods and apparatus are disclosed herein for optimizing link adaptation for a communication session with a user device. Embodiments of a method performed by a network node of a telecommunications network to optimize link adaptation for a communication session with a user device are disclosed herein. The method comprises receiving a link adaptation state update message from a user device, wherein the link adaptation state update message comprises one or more link adaptation state information elements associated with a communication link between the network node and the user device. The method further comprises determining one or more link adaptation parameters for communicating with the user device based on the link adaptation state update message. In some embodiments disclosed herein, the one or more link adaptation state information elements comprises a Channel State Information Measurement (CSI-M) report, and the CSI-M report comprises measurements of channel state associated with a coverage area of a radio cell and/or with different spatial areas of a radio cell.

Some such embodiment disclosed herein may provide that the measurements of channel state associated with different spatial areas of the radio cell are defined by one or more Synchronization Signal Block (SSB) beam coverage areas or one or more Channel State Information Reference Signal (CSI-RS) coverage areas. According to some such embodiments disclosed herein, the measurements of channel state comprise measurements of one or more of Channel Quality Indicator (CQI) rank, precoding matrix indicator (PMI), Signal-to-Noise ratio (SNR), or Signal-to-Interference-plus-Noise ratio (SINR). In some embodiments disclosed herein, the measurements of channel state are reported according to time and/or frequency granularity specified by one or more of wideband, per sub-band, per physical resource block (PRB), per resource block group (RBG), per transmission time window, or a combination of at least one time reporting granularity and at least one frequency reporting granularity.

Some embodiment disclosed herein may provide that the one or more link adaptation state information elements further comprises an indication of an uncertainty measure for one or more information elements of the CSI-M report. According to some embodiments disclosed herein, the one or more link adaptation state information elements comprises a Channel State Information Prediction (CSI-P) report, and the CSI-P report comprises one or more predictions or estimates of channel state associated with a coverage area of a radio cell and/or with different spatial areas of a radio cell. In some such embodiments disclosed herein, the one or more predictions or estimates of the channel state associated with different spatial areas of the radio cell are defined by one or more SSB beam coverage areas or one or more CSI-RS coverage areas. Some such embodiment disclosed herein may provide that the CSI-P report comprises one or more predictions of one or more of CQI rank, PMI, SNR, and SINR. According to some embodiments disclosed herein, the one or more predictions are reported according to time and/or frequency granularity specified by one or more of wideband, per sub-band, per PRB, per RBG, per transmission time window, or a combination of at least one time reporting granularity and at least one frequency reporting granularity. In some embodiments disclosed herein, the one or more link adaptation state information elements further comprises an indication of an uncertainty measure for one or more information elements of the CSI-P report.

Some embodiment disclosed herein may provide that the one or more link adaptation state information elements comprises an indication of a mobility state of the user device, and the mobility state comprises one or more of velocity, acceleration, or type of mobility. According to some such embodiments disclosed herein, the indication comprises a binary indicator configured to be set to one of a first value to indicate that the user device is static or a second value to indicate that the user device is moving with a speed above a specified threshold. In some such embodiments disclosed herein, wherein the indication comprises one of a plurality of values each associated with a different velocity threshold.

Some embodiment disclosed herein may provide that the one or more link adaptation state information elements comprises an indication of a channel fading state experienced by the user device. According to some such embodiments disclosed herein, the indication comprises a fading indication indicating that the user device is affected by shadow fading and/or fast fading. In some embodiments disclosed herein, the one or more link adaptation state information elements comprises an indicator of a measured interference state experience by the user device. Some such embodiment disclosed herein may provide that the indicator comprises one or more of measurements of a maximum or minimum peak interference measured over a set of time-frequency resources, a mean interference measured over a set of time-frequency resources, or a peak-to-average ratio of interference measured over a set of time-frequency resources. According to some such embodiments disclosed herein, the indicator is configured to be reported per wideband, per sub-band, per PRB, per RBG, per SSB beam coverage areas, per CSI-RS beam coverage area, or a combination of at least one frequency granularity and at least one spatial granularity.

In some embodiments disclosed herein, the one or more link adaptation state information elements comprises an indicator of a predicted interference state experience by the user device. Some such embodiment disclosed herein may provide that the indicator comprises one or more predictions of a peak interference predicted or estimated over a set of time-frequency resources, a mean interference predicted or estimated over a set of time-frequency resources, or a first and second statistical moments of interference predicted or estimated over a set of time-frequency resources. According to some such embodiments disclosed herein, the indicator is configured to be reported per wideband, per sub-band, per PRB, per RBG, per SSB beam coverage areas, per CSI-RS beam coverage area, or a combination of at least one frequency granularity and at least one spatial granularity.

In some embodiments disclosed herein, the one or more link adaptation state information elements comprises one or more measurements of a downlink data transmission state in at least a previous transmission time interval (TTI). Some embodiment disclosed herein may provide that the one or more link adaptation state information elements comprises one or more user-device manufacturing information elements. According to some such embodiments disclosed herein, the one or more user-device manufacturing information elements comprises one or more of a user device model, a user device manufacturer, a user device receiver type, a user device receiver hardware, a user device chipset model, a user device chipset manufacturer, a user device processor type, a user device processor model, a user device operating system, or a user device antenna model.

In some embodiments disclosed herein, the one or more link adaptation state information elements comprises one or more user device configuration information elements used for determining any of the one or more link adaptation state information elements. Some such embodiment disclosed herein may provide that the one or more user device configuration information elements comprises one or more of a type of algorithm, an algorithm configuration, an algorithm hyperparameter type and value, a type of filtering operation, or a filtering hyperparameter type and value.

According to some embodiments disclosed herein, the method further comprises transmitting a link adaptation state request message to the user device to configure or trigger a link adaptation state reporting from the user device. In some such embodiments disclosed herein, the link adaptation state request message comprises an indication of a type of reporting requested by the network node, and the type of reporting comprises one or more of periodic reporting, aperiodic reporting, or event-triggered reporting. Some such embodiment disclosed herein may provide that the type of reporting comprises periodic reporting, and the link adaptation state request message further comprises one or more indications of a start time, a periodicity, or a duration of reporting. According to some such embodiments disclosed herein, the type of reporting requested by the network node comprises one or more indications to start, stop, pause, resume or modify the link adaptation state reporting for at least one type of link adaptation state information.

In some embodiments disclosed herein, the link adaptation state request message further comprises an indication of a type of link adaptation state information requested by the network node. Some such embodiment disclosed herein may provide that the indication of the type of link adaptation state information requested by the network node comprises an indication of a CSI-M report. According to some such embodiments disclosed herein, the indication of the type of link adaptation state information requested by the network node comprises an indication to report a CSI-P report. In some such embodiments disclosed herein, the indication of the type of link adaptation state information requested by the network node comprises an indication to report at least one uncertainty measure for one or more information elements of a CSI-M report. Some such embodiment disclosed herein may provide that the indication of the type of link adaptation state information requested by the network node comprises an indication to report at least one uncertainty measure for one or more information elements of a CSI-P report. According to some such embodiments disclosed herein, the indication of the type of link adaptation state information requested by the network node comprises an indication to report a user device mobility state. In some such embodiments disclosed herein, the indication of the type of link adaptation state information requested by the network node comprises an indication to report a channel fading state experience by the user device. Some such embodiment disclosed herein may provide that the indication of the type of link adaptation state information requested by the network node comprises an indication to report a measured interference state experienced by the user device.

According to some such embodiments disclosed herein, the indication of the type of link adaptation state information requested by the network node comprises an indication to report a predicted interference state experienced by the user device. In some such embodiments disclosed herein, the indication of the type of link adaptation state information requested by the network node comprises an indication to report one or more measurements of a downlink data transmission state in at least a previous TTI. Some such embodiment disclosed herein may provide that the indication of the type of link adaptation state information requested by the network node comprises an indication to report one or more user-device manufacturing information elements. According to some such embodiments disclosed herein, the indication of the type of link adaptation state information requested by the network node comprises an indication to report one or more user device configuration information elements used for determining any of the one or more link adaptation state information elements. In some such embodiments disclosed herein, the link adaptation state request message further comprises, for each of the one or more link adaptation state information elements, an indication of one or more reporting granularities in a frequency domain, the one or more the reporting granularities comprising per wideband, per sub-band, per PRB, or per RBG reporting. Some such embodiment disclosed herein may provide that wherein the link adaptation state request message further comprises, for each of the one or more link adaptation state information elements, an indication of one or more reporting granularities in a spatial domain, the one or more the reporting granularities comprising per SSB beam coverage areas or per CSI-RS beam coverage area. According to some such embodiments disclosed herein, the link adaptation state request message further comprises, for each of the one or more link adaptation state information elements, an indication of one or more reporting granularities in a time domain, the one or more the reporting granularities comprising per TTI, per transmission time window, per packet transmission, or per group of packets.

In some embodiments disclosed herein, the method further comprises receiving a link adaptation state acknowledge message from the user device indicating a successful or partially successful initialization of a link adaptation state reporting procedure. Some embodiment disclosed herein may provide that the method further comprises receiving a link adaptation state failure message from the user device indicating an unsuccessful initialization of a link adaptation state reporting procedure. According to some embodiments disclosed herein, the method further comprises determining the one or more link adaptation parameters based on machine learning (ML).

Embodiments of a network node are also disclosed herein. In some embodiments disclosed herein, the network node is adapted to receive a link adaptation state update message from a user device, wherein the link adaptation state update message comprises one or more link adaptation state information elements associated with a communication link between the network node and the user device. The network node is further adapted to determine one or more link adaptation parameters for communicating with the user device based on the link adaptation state update message. Some embodiment disclosed herein may provide that the network node is also adapted to perform any of the operations attributed to the network node above.

Embodiments of a network node are also disclosed herein. According to some embodiments disclosed herein, the network node comprises one or more transmitters, one or more receivers, and processing circuitry associated with the one or more transmitters and the one or more receivers. The processing circuitry is configured to cause the network node to receive a link adaptation state update message from a user device, wherein the link adaptation state update message comprises one or more link adaptation state information elements associated with a communication link between the network node and the user device. The processing circuitry is further configured to cause the network node to determine one or more link adaptation parameters for communicating with the user device based on the link adaptation state update message. In some embodiments disclosed herein, the processing circuitry is also configured to cause the network node to perform any of the operations attributed to the network node above.

Embodiments of a method performed by a user device in a telecommunications network to optimize selection of radio resources and transmission format for a communication session with a network node are also disclosed herein. The method comprises determining a link adaptation report for communicating with the network node. The method further comprises transmitting a link adaptation state update message to the network node, the link adaptation state update message comprising the link adaptation report comprising one or more link adaptation state information elements associated with a communication link between the network node and the user device.

Some embodiment disclosed herein may provide that the method further comprises receiving a link adaptation state request message indicating a request of the network node to configure the user device for link adaptation reporting, and determining the one or more link adaptation state information elements to be reported to the network node based on the link adaptation state request message. According to some such embodiments disclosed herein, the method further comprises, in response to the link adaptation state request message, determining that the request of the network node can be fulfilled fully or in part, and transmitting a link adaptation state acknowledge message indicating a successful or partly successful initialization of a link adaptation state reporting procedure. In some such embodiments disclosed herein, the link adaptation state acknowledge message comprises a list of link adaptation information or parameters that can be reported, a periodicity with which link adaptation reports can be transmitted to the network node, a frequency domain granularity with which link adaptation information or parameters can be reported, a time domain granularity with which link adaptation information or parameters can be reported, a recommended granularity to use based on a user-device-experienced radio environment, and a spatial domain granularity with which link adaptation information or parameters can be reported. Some such embodiment disclosed herein may provide that the method further comprises determining, by the user device, one or more link adaptation parameter values based on machine learning (ML). According to some embodiments disclosed herein, the method further comprises, in response to the link adaptation state request message, determining that the request of the network node cannot be fulfilled, and transmitting a link adaptation state acknowledge message indicating an unsuccessful initialization of a link adaptation state reporting procedure.

Embodiments of a user device of a telecommunications network are also disclosed herein. In some embodiments disclosed herein, the user device is adapted to determine a link adaptation report for communicating with a network node. The user device is further adapted to transmit a link adaptation state update message to the network node, the link adaptation state update message comprising the link adaptation report comprising one or more link adaptation state information elements associated with a communication link between the network node and the user device. Some embodiment disclosed herein may provide that the user device is also adapted to perform any of the operations attributed to the user device above.

Embodiments of a user device are also disclosed herein. According to some embodiments disclosed herein, the user device comprises one or more transmitters, one or more receivers, and processing circuitry associated with the one or more transmitters and the one or more receivers. The processing circuitry is configured to cause the user device to determine a link adaptation report for communicating with a network node. The processing circuitry is further configured to cause the user device to transmit a link adaptation state update message to the network node, the link adaptation state update message comprising the link adaptation report comprising one or more link adaptation state information elements associated with a communication link between the network node and the user device. In some embodiments disclosed herein, the processing circuitry is also configured to cause the user device to perform any of the operations attributed to the user device above.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary implementation of link adaptation in a radio access network (RAN);

FIG. 2 illustrates one example of a cellular communications system according to some embodiments disclosed herein;

FIGS. 3 and 4 illustrate example embodiments in which the cellular communication system of FIG. 3 is a Fifth Generation (5G) System (5GS);

FIG. 5 illustrates exemplary communication flows and operations for enabling a radio network node to optimize link adaptation for a communication session with a user device according to some embodiments disclosed herein;

FIG. 6 illustrates an example in which a user device reports an indication of the amount/fraction of data correctly/incorrectly received or decoded for a specific data packet gathered over several transmissions of such packets occurring in different transmission time intervals (TTIs), according to some embodiments disclosed herein;

FIG. 7 illustrates exemplary communication flows and operations for transmitting a link adaptation state request message to the user device to configure or trigger a link adaptation state reporting from the user device according to some embodiments disclosed herein;

FIGS. 8A and 8B illustrates exemplary communication flows and operations for successful and unsuccessful initialization of link adaptation reporting, respectively, at the user device upon receiving link adaptation state request message from a network node according to some embodiments disclosed herein;

FIG. 9 illustrates exemplary operations of a network node for optimizing link adaptation for a communication session with a user device according to some embodiments disclosed herein;

FIGS. 10A and 10B illustrate exemplary operations of a user device to optimize the selection of radio resources and transmission format for a communication session with a network node according to some embodiments disclosed herein;

FIG. 11 illustrates a radio access node according to some embodiments disclosed herein;

FIG. 12 illustrates a virtualized embodiment of the radio access node of FIG. 11 according to some embodiments disclosed herein;

FIG. 13 illustrates the radio access node of FIG. 11 according to some other embodiments disclosed herein;

FIG. 14 illustrates a UE according to some embodiments disclosed herein; and

FIG. 15 illustrates the UE of FIG. 14 according to some other embodiments disclosed herein.

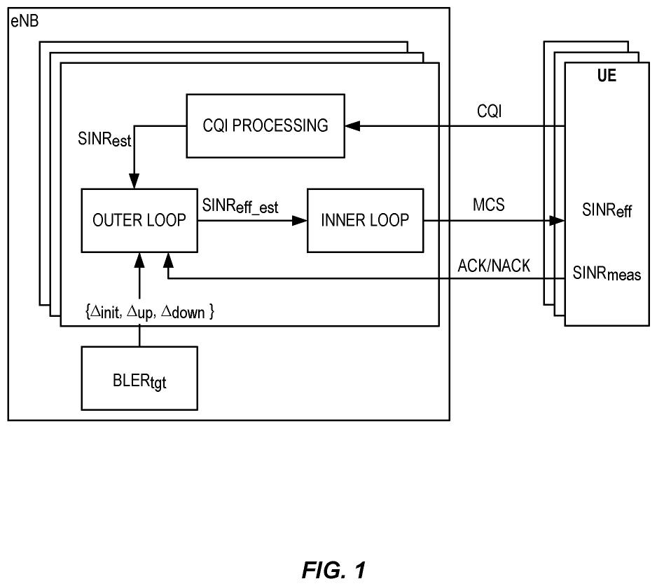

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In particular, state of the art communication systems, such as the 3GPP LTE and 5G NR systems, traditionally configure a fixed BLER target common for all user devices with the same type of traffic. In some implementations, the same BLER target is configured for all user devices in the coverage area of a radio network node regardless of their traffic type. Furthermore, the BLER target is typically not adapted over time but kept fixed for all links.

While this approach can simplify some implementation aspects of the radio communication system, in general it leads to suboptimal system performance due to non-stationary and rapidly varying channel conditions, both over time and frequency domain. The BLER target is supposed to provide a control parameter to adjust the configuration setting of a communication link to its channel state to adapt to deep channel fade or interference.

On one hand, configuring the same BLER target for all users with the coverage area of a radio network node (or worse, within larger parts of the network) can be problematic as different users typically experience different channel states and interference. For instance, it would be desirable to configure high BLER targets to make the communication link robust from rapidly varying interference, at the expense of higher usage of communication resources. However, user devices closer to the transmitter are less affected by rapidly varying interference than user devices located further away from the transmitter. Therefore, setting a high BLER target for all users would potentially result in a system performance degradation as fewer radio resources would be made available for user devices with good channel conditions. A similar argument can be made if the system would configure a too low BLER target for all users. In this case, the system would optimistically assume robust communication links for all users, which would be harmful for users affected by strong interference.

On the other hand, keeping the BLER target fixed within a communication session can only allow tracking of average channel behavior and therefore cannot fully exploit the potential of a communication link. Being able to adapt the BLER target within a communication session is desirable to set the configuration parameters for the communication link more opportunistically to increase the overall spectral efficiency and quality of service (e.g., by setting a higher BLER target when the communication link suffers from higher interference or bad channel quality, or setting lower BLER targets when the channel conditions are more favorable).

However, adapting the BLER target of a communication link dynamically during a communication session is not trivial as it adds an additional control loop within the link adaptation. On one hand, the BLER target is used as input to the outer loop link adaptation (OLLA) algorithm, which typically requires hundreds of milliseconds to control the actual BLER toward the target BLER. Since the convergence time is not constant, changing the BLER target should be done carefully to avoid instability issues in OLLA. On the other hand, the channel quality reports from the user device are typically the result of filtered measurements which hide the channel variations that the BLER adaptation algorithm should track and compensate for.

More recent approaches to link adaptation have considered machine learning based solutions to optimize the performance of link adaptation. In one relevant case, machine learning has been suggested to optimize the BLER target used for the link adaptation algorithm in a communication session with a user device. In this case, machine learning is not used to design a new link adaptation algorithm per se (i.e., the other loop and the inner loop link adaptation algorithms), but only for tuning a hyper-parameter of the link adaptation algorithm: the BLER target. Different machine learning based algorithms have been suggested to configure a proper BLER target for link adaptation, such as regression models of the spectral efficiency, multi-class classifiers, armed bandit, contextual multi-armed bandit (CMAB), reinforcement learning, Thompson Sampling, and the like. While configuring the link adaptation algorithm with a different BLER target for different user devices can match the corresponding channel and interference environment, the resulting solutions cannot achieve the full performance of the radio link between the user device and the network node as the outer loop link adaptation design retains all its drawbacks (such as slow convergence rate to a good correction of the SINR estimate) which in turns limits the achievable performance.

Aspects of the present disclosure and their embodiments may provide solutions to the aforementioned or other challenges. There are, proposed herein, various embodiments which address one or more of the issues disclosed herein. Computer implemented methods performed at a network node of a telecommunications network for configuring a user device for enhanced channel state information (CSI) reporting are disclosed herein. In some embodiments, the method comprises receiving a link adaptation state update message from the user device comprising one or more link adaptation state information associated with the communication link between the network node and the user device, and determining one or more link adaptation parameters for communicating with the user device based on link adaptation state update message. In some embodiments, the method may further comprise the network node transmitting a link adaptation state request message to the user device to configure or trigger link adaptation state reporting from the user device, receiving a link adaptation state acknowledgement message indicating a successful configuration of the link adaptation state reporting procedure, or receiving a link adaptation state failure message indicating a failed configuration of the link adaptation state reporting procedure.

Computer implemented methods performed by a user device in a telecommunication network for optimizing the selection of radio resources and transmission format for a communication session with a network node are also disclosed herein. In some embodiments, the method comprises determining a link adaptation report for communicating with a network node, and transmitting a link adaptation state update message to a network node comprising one or more link adaptation state information associated with the communication link between the network node and the user device. Some embodiments characterizing the method at the user device follow from the embodiments characterizing the method at the network node.

Embodiments may provide one or more of the following technical advantage(s). In particular, the proposed method allows for optimization of the transmission format for transmissions occurring over a communication link between a user device and a network node. One advantage of the method herein disclosed is to enable the network node to optimize the link adaptation parameters, such as MCS index, modulation order, code rate, transmission rank, and the like, by means of link adaptation state information reported by the user device. As such, the link adaptation parameters may be better optimized from the very beginning of a communication session, which is especially beneficial in the case of short packet transmission (when conventional link adaptation based optimization to achieve a certain BLER target is known to be ineffective).

Another advantage of the method is to enable more accurate link adaptation information to be used by a network node when selecting link adaptation parameters for configuring a transition to a user device. Traditional link adaptation methods based on CSI rely on proprietary function mappings between SINR and CQI values, which are not shared between user device and network node. By enabling a user device to directly share richer link adaptation state information with a network node, the network node can configure link adaptation parameters that can lead to better user performance (e.g., in terms of improved spectral efficiency and latency), better user experience, and an overall better network performance.

Before discussing methods and apparatus for transmitting link adaptation state information in greater detail, exemplary cellular communications systems in which some embodiments of the present disclosure may be implemented are first discussed. In this regard, the following terms are defined:

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) or “user device” in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from user device according to physical layer properties and parameters inherent to that element. In some embodiments, in Multiple TRP (multi-TRP) operation, a serving cell can schedule user device from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, user device is scheduled by the same DCI for both TRPs and in multi-DCI mode, user device is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

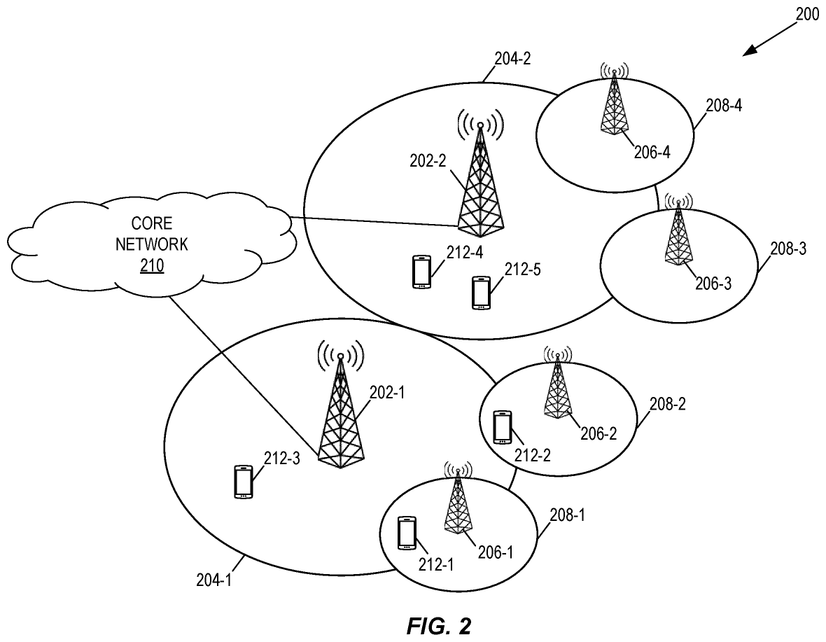

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

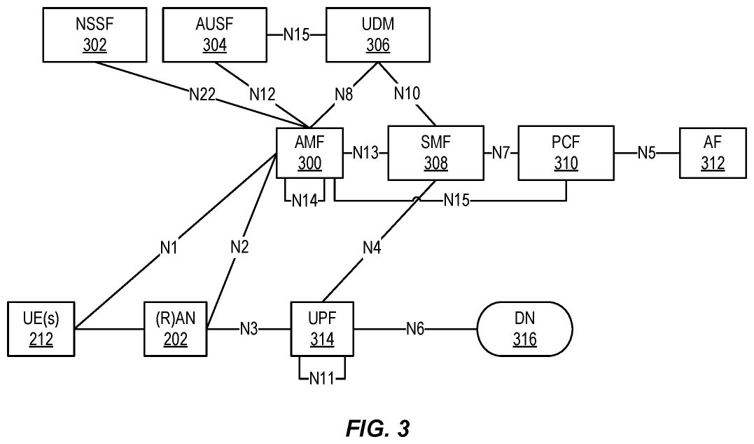

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R(AN) 202 comprises base stations, e.g., such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the user device 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the user device 212. N8 and N10 are defined because the subscription data of the user device 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and a Data Network (DN) 316 (which provides Internet access, operator services, and/or the like) for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

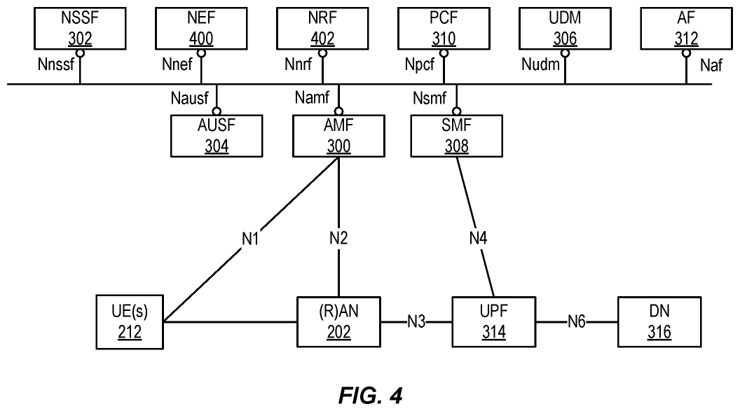

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g., Namf for the service based interface of the AMF 300 and Nsmf for the service based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides user device-based authentication, authorization, mobility management, etc. A user device 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a user device 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the user device 212. The Data Network (DN) 316, not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

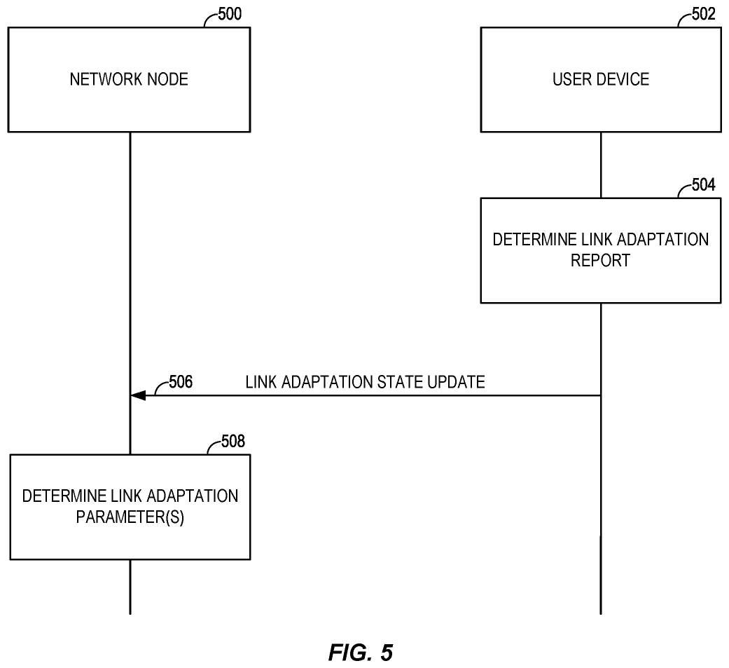

The subject matter disclosed herein provides computer implemented methods and systems for enabling a radio network node to optimize link adaptation for a communication session with a user device. In some embodiments, the method comprises receiving a link adaptation state update message from a user device comprising one or more link adaptation state information associated with the communication link between the network node and the user device, and determining one or more link adaptation parameters for communicating with the user device based on link adaptation state update message. The method is illustrated in FIG. 5.

In one embodiment of the invention, the link adaptation state update message received from the user device may comprising one or more link adaptation state information elements. In some embodiments, the one or more link adaptation state information elements may comprise a Channel State Information Measurement (CSI-M) report, comprising, for instance, measurements of channel state associated with different spatial areas of the radio cell, as defined, for instance, by a coverage area of a radio cell, and/or by the following:
One or more SSB beam coverage area;
One or more CSI-RS coverage area.

The Channel State Information Measurement (CSI-M) report may be configured to provide measurements of Channel Quality Indicator (CQI), rank, and precoding matrix indicator (PMI), Signal-to-Noise ratio (SNR), and Signal-to-interference-plus-Noise ratio (SINR). Therefore, the user device may determine any such measurement from different SSB beams or different CSI-RS beams of a radio cell. The CSI measurements reported per different cell area may additionally be configured to be reported with different time and frequency granularity, such as the following:
Wideband (i.e., one indicator value representing the channel fading in the entire frequency band measured by the user device);
Per sub-band (i.e., one indicator value representing the channel fading in a fraction of the frequency band measured by the user device). For instance, a sub-band may be comprised by an individual physical resource block (PRB or PRB pair), or groups of PRBs;
Per transmission time window (i.e., the reported information is associated with a certain time interval), which could be expressed, for instance, in seconds or fractions thereof, in terms of TTIs or groups thereof, in terms radio frames or groups thereof, etc.;
A combination of at least one time and at least one frequency reporting granularity.

According to some embodiments, the one or more link adaptation state information elements may comprise a Channel State Information Prediction (CSI-P) report, comprising, for instance, predictions of channel quality indicator (CQI), rank, and precoding matrix indicator (PMI), associated with different spatial areas of the radio cell. For instance, the predictions may be associated with a coverage area of a radio cell, and/or with the following:
One or more SSB beam coverage area;
One or more CSI-RS coverage area.

The CSI-P report may be configured to provide predictions or estimates of Channel Quality Indicator (CQI), rank, and precoding matrix indicator (PMI), Signal-to-Noise ratio (SNR), and Signal-to-interference-plus-Noise ratio (SINR). Therefore, the user device may determine any such measurement from different SSB beams or different CSI-RS beams of a radio cell. The CSI predictions/estimates reported per different cell area may additionally be configured to be reported with different time and frequency granularity, such as the following:
Wideband (i.e., one indicator value representing the channel fading in the entire frequency band measured by the user device);
Per sub-band ((i.e., one indicator value representing the channel fading in a fraction of the frequency band measured by the user device). For instance, a sub-band may be comprised by an individual physical resource block (PRB or PRB pair), or groups of PRBs;
Per transmission time window (i.e., the reported information is associated with a certain time interval), which could be expressed, for instance, in seconds or fractions thereof, in terms of TTIs or groups thereof, in terms radio frames or groups thereof, etc.;
A combination of at least one time and at least one frequency reporting granularity;

Some embodiments may provide that the one or more link adaptation state information elements may comprise an indication of at least an uncertainty measure for one or more information elements of the CSI-M report, such as for one or more measurements of CQI, rank, PMI, SNR, and SINR. This information could be reported or be configured to be reported similarly to the CSI-M report.

In some embodiments, the one or more link adaptation state information elements may comprise an indication of at least an uncertainty measure for one or more information elements of the CSI-P report, such as for one or more predictions/estimates of CQI, rank, PMI, SNR, and SINR.

According to some embodiments, the one or more link adaptation state information elements may comprise an indication of the user device mobility state, such as velocity, acceleration, type of mobility, and the like. Some embodiments may provide that this is realized using a binary indicator being configured with value 1 (or, alternatively 0) if the user device is static, and value 0 (or, alternatively, 1) if the user device moves with speed above a certain threshold. In some embodiments, the indicator may be configured with more than two values, with each value being associated with a different velocity threshold. According to some embodiments, the indicator may be configured to report at least one out of 2^{K}^{₁} values, with K₁≥1 integer, where each reported value is associated with a velocity threshold. Therefore, the user device may report one of the possible 2^{K}^{₁} values if the corresponding velocity threshold is exceeded.

Some embodiments may provide that the one or more link adaptation state information elements may comprise an indication of the channel fading state experience by the user device. For instance, the user device may report whether it is affected by shadow fading or fast fading. It may alternatively or additionally report which type of fading is dominant in the channel degradation. In addition, the user device may report an indicator indicating the magnitude of the experience channel fading. In some embodiments, the fading indicator may be configured to report at least one out of 2^{K}^{₂} values, with K₂≥1 integer, where each reported value is associated with a fading intensity. For example, the user device may report a fading indicator equal to 0 is the channel is affected only by stationary or large-scale channel attenuation, or it may report an increasing number indicating a more severe fast fading attenuation. According to some embodiments, the user device reports the channel coherence time. The coherence time is commonly defined as the time the channel is assumed to be constant. There is not an exact definition for the coherence time, but it is normally inversely proportional to the terminal velocity. The normalized autocorrelation function over channel estimates in the time domain can be used to estimate the coherence time, values close to 1 means highly correlated channel estimates. The network can in one embodiment configure a value in range of [0, 1] defining the coherence time threshold. Some embodiments may provide that the user device can report the normalized correlation values in certain time lags.

Finally, the fading indicator may be reported with different frequency and/or spatial granularity, such as the following:
Per wideband;
Per sub-band (such as, per PRB or PRB pair, per groups of PRBs, etc.);
Per SSB beam coverage area;
Per CSI-RS beam coverage area;
A combination of at least one frequency and spatial granularity.

In some embodiments, the one or more link adaptation state information elements may comprise an indicator of the measured interference state experience by the user device. The measured interference state may comprise measurements and or predictions of different types of interference, such as the following:
The maximum or minimum peak interference measured over a set of time-frequency resource (optionally including the time-frequency resource element where the peak occurred);
The mean interference measured over a set of time-frequency resources;
The peak to average ratio of the interference measured over a set of time-frequency resources. A high value, close to 1, will indicate that the majority of interference measurements experienced by the device are close in magnitude.
The first and second statistical moments of the interference measured over a set of time-frequency resource

According to some embodiments, the peak interference indicator may be configured to report at least one out of 2^{K}^{₃} values, with K₃≥1 integer, where each reported value is associated with a fading intensity. For example, the user device may report a peak interference indicator equal to 0 if there is no interference peak measured in the frequency band of interest, or a value strictly greater than zero to indicate the presence of an interference peak in the bandwidth of interest, with increasing reported values being associated with stronger peak interference. In one example, each of the 2^{K}^{₃} configurable values of the indicator is associated with an interference peak intensity threshold Iⱼ, with j=0, . . . 2^{K}^{_{3−1}}. In a related example, the user device reports the percentage of values that are above a certain threshold in respect to its peak-value. For example, the percentage of values above 0.5× peak-interference value. This would allow the user devices to have a unified method to report its experienced interference peaks over a set of time-frequency resources.

In some embodiments, the autocorrelation function is reported over a certain set of resources. This can enable to detect the periodical interference at the device, both in time and in frequency, this can be used by the network to predict future interference values. The user device could for example be configured to report the magnitude and lag-values above a certain threshold in respect to its zero-lag component.

Finally, the measured interference state indicator may be configured to be reported with difference frequency or spatial, such as the following:
Per wideband;
Per sub-band (such as, per PRB or PRB pair, per groups of PRBs, etc.);
Per SSB beam coverage area;
Per CSI-RS beam coverage area;
A combination of at least one frequency and spatial granularity.

In some embodiments, the one or more link adaptation state information elements may comprise, an indicator of the predicted interference state experience by the user device. The measured interference state may comprise measurements and or predictions of different types of interference, such as the following:
The peak interference predicted/estimated over a set of time-frequency resources;
The mean interference predicted/estimated over a set of time-frequency resources;
The first and second statistical moments of the interference predicted/estimated over a set of time-frequency resources.

Finally, the predicted interference indicator may be configured to be reported with different frequency or spatial granularity, such as the following:
Per wideband;
Per sub-band;
Per SSB beam coverage area;
Per CSI-RS beam coverage area;
A combination of at least one frequency and spatial granularity.

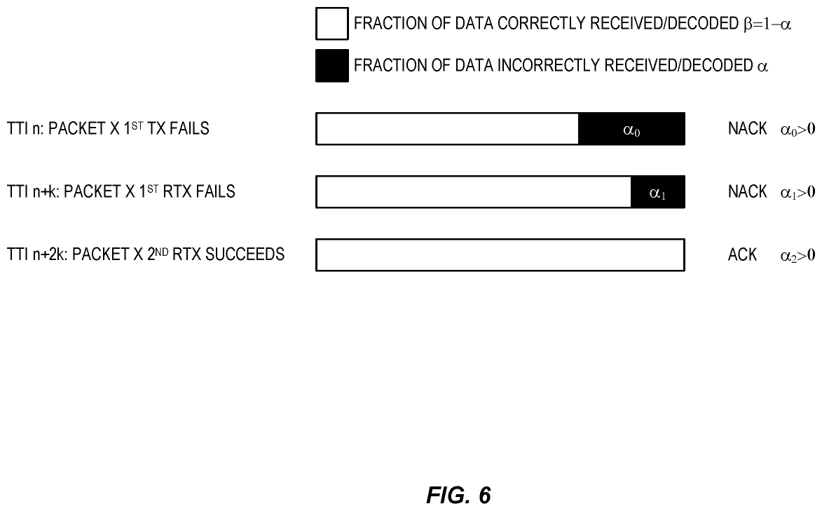

Some embodiments may provide that the one or more link adaptation state information elements may comprise one or more measurements of the downlink data transmission state in at least a previous transmission time interval (TTI). In some embodiments, the user device may report an indication of the amount of correctly (or, alternatively, incorrectly) received/decoded information associated with a packet transmission. In one example, as illustrated in FIG. 6, the user device reports an indication of the amount/fraction of data correctly/incorrectly received or decoded for a specific data packet gathered over several transmissions of such packets occurring in different TTIs. The indication of the transmission performance, such as the fraction of data correctly/incorrectly received/decoded, could be reported for each individual transmission of the packet (e.g., until a successful transmission is acknowledged) or it could be pre-processed by the user device by, for instance, averaging the performance over the TTIs where the packet has been transmitted unsuccessfully. Additional statistical moments, such as standard deviation and variance of the transmission performance could be reported. The packet ID could also be reported by the user device.

In one example, the user device may report one or more cumulative downlink performance indicators associated with the transmission of a group data packets. For instance, the user device may be configured to report one or more statistical information of the downlink transmission state among the following:
First statistical momentum (e.g., mean, average) of the amount or the fraction of data correctly or incorrectly received or decoded for a group of data packets;
Second statistical momentum (e.g., standard deviation, variance) of the amount or the fraction of data correctly or incorrectly received or decoded for a group of data packets;
Maximum and/or minimum amount or fraction of data correctly or incorrectly received or decoded for a group of data packets.

The group of data packet for which the user device should provide a downlink performance indication could be configured by the network node. For instance, the network node could indicate a starting packet from which performance should be evaluated, and a number of packets to be used for reporting the performance. In some embodiments, the network node may indicate a starting time to compute the performance and a window of time for which the performance should be calculated (in this case, the number of packets will depend on the packets transmitted within the measuring window). The user device may be further configured to report the performance of the downlink data transmission periodically or on event based.

Some embodiments may provide that the one or more link adaptation state information elements may comprise one or more user-device manufacturing information elements. The user-device manufacturing information elements may comprise one or more of a user device model, a user device manufacturer, a user device receiver type, a user device receiver hardware, a user device chipset model, a user device chipset manufacturer, a user device processor type, a user device processor model, a user device operating system and a user device antenna model. Providing such information elements allow measurements or predictions of link adaptation state information made by different user devices to be distinguished in terms of hardware and software, which may affect the accuracy and uncertainly of the measurements or predictions.

Some embodiments may additionally provide that the one or more link adaptation state information elements may comprise one or more user device configuration information elements used for determining any of the link adaptation state information elements. In one example, the user device configuration information elements may be associated with algorithms used for determining any of the link adaptation state information element, such as a type of algorithm, one or more hyperparameters used to configure the algorithm (including, e.g., a type and a value of each hyperparameter). In addition, the user device configuration information elements used for determining any of the link adaptation state information elements may include a type of filtering operation, and any corresponding configuration values, used to determine measurements and/or estimates of link adaptation state information. This may include, for instance, a type of filtering and an associated configuration for the computation of CSI information (such as filtered CQI), SINR, RSRP, interference measurements, and the like.

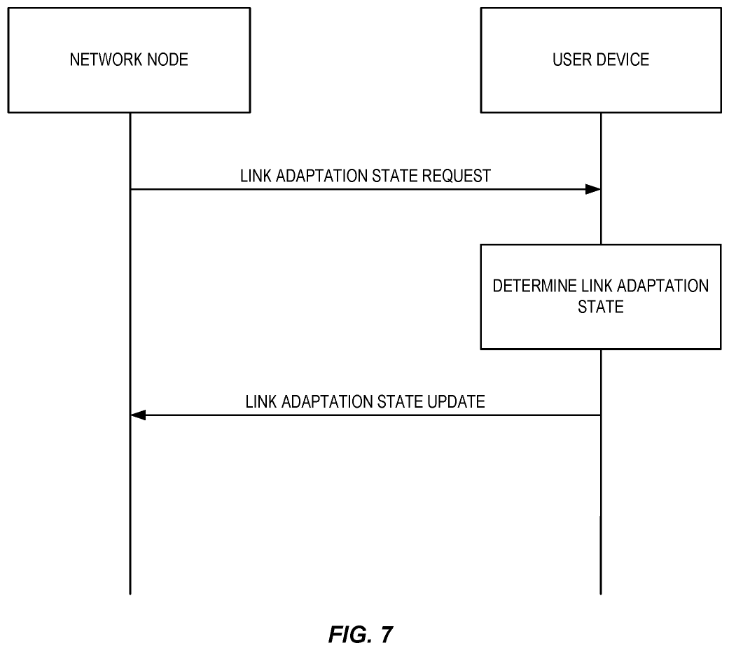

In some embodiments, the method performed by the network node may further comprise transmitting a link adaptation state request message to the user device to configure or trigger a link adaptation state reporting from the user device. FIG. 7 illustrates this embodiment, wherein the network node transmits a link adaptation state update request message to user device to configure it for link adaptation state reporting, in response, the network node receives a link adaptation state update message from the user device comprising one or more of the requested link adaptation state information.

Some embodiments may provide that the link adaptation state request message configures the user device to report a link adaptation state information comprising one or more information elements. In some embodiments, the one or more information elements may comprise an indication to start/stop/pause/resume or modify a link adaptation state reporting.

According to some embodiments, the one or more information elements may comprise an indication of the type of link adaptation state reporting, such as periodic reporting, or aperiodic reporting (one-shot), event triggered reporting. If the user device is configured to report link adaptation state periodically, the link adaptation state request message may additionally comprise an indication of one or more of the following:
A starting time for the reporting, such as a TTI number, a frame identifier, etc.;
An indication of at least one periodicity for link adaptation state reporting. Different periodicities could be configured, for instance, based on the user device speed. In one example, more frequent reporting (i.e., shorter reporting period) may be configured in case of faster user device speed. In another example, different frequencies of reporting are configured in association to the battery level of the user device. Additionally, the user device may be configured to select a suitable link adaptation state reporting frequency and signal such information to the network node;
An indication of a stopping criteria for reporting, such as in case of low battery level or when the user device operates or is configured to operate in energy saving mode;
An indication of the reporting duration. This can be indicated, for instance with a time window expressed in absolute value (e.g., in milliseconds, seconds, minutes, hours, etc.), or in number of TTIs, number of radio frames etc. Similar to the reporting periodicity, different link adaptation state request message may comprise different reporting windows in association, for instance, to different battery levels of the user device;
An indication that the user device should be using relative reporting. The user device can report the state information in respect to a previously reported state information. For example, instead of always reporting an absolute RSRP value for a certain SSB beam, the user device can report a relative-RSRP value in order to save signaling. The user device can also skip reporting a certain value if there is no change in comparison to previous state.

An event triggered reporting in some embodiments may involve the user device being configured with an event that will trigger a state information report (configured to report the user device's fast fading state). The user device can be configured to update the state information if its value has changed, or changed with a certain threshold.

Some embodiments may provide that the one or more information elements may comprise an indication of the link adaptation state information requested by the network node, which may comprise one or more information elements among the following:
A Channel State Information Measurement (CSI-M) report;
A Channel State Information Prediction (CSI-P) report;
An indication of at least one uncertainty measure for one or more information elements of the Channel State Information Measurement (CSI-M) report;
An indication of at least one uncertainty measure for one or more information elements of the Channel State Information Prediction (CSI-P) report;
An indication of the user device mobility state;
An indication of the channel fading state experience by the user device;
An indicator of the measured interference state experience by the user device;
An indicator of the predicted interference state experience by the user device;
One or more measurements of the downlink data transmission state in at least a previous transmission time interval (TTI).

In some embodiments, the one or more information elements may comprise, for each requested link adaptation state information, an indication of one or more reporting granularity in frequency domain such as the following:
Wideband reporting;
Per sub-band reporting;
Per physical resource block (PRB) reporting;
Per resource block group (RBG) reporting, wherein an RBG may comprise a group of PRBs;
Per bandwidth part reporting;
Per bandwidth segment reporting.

Some embodiments may provide that the one or more information elements may comprise, for each requested link adaptation state information, an indication of one or more reporting granularity in spatial domain. In some embodiments, the spatial granularity of the requested measurements is defined in association to one or more downlink reference signal, such as the following:
Per Common Reference Signals (CRS);
Per Channel State Information Reference Signals CSI-RS;
Per Synchronization Signal Block (SSB) reference signal.

In some embodiments, the first network node may request one or more type of link adaptation state information to be reported in association to one or more SSB beam coverage area and/or one or more CSI-RS beam coverage area, where an SSB beam coverage area (respectively CSI-RS beam coverage area) can be defined in relation to an SSB beam index (respectively CSI-RS beam index).

In some embodiments, the one or more information elements may comprise, for each requested link adaptation state information, an indication of at least one granularity in time domain for reporting, such as the following:
Per transmission time interval (TTI)I (i.e., one shot);
Per transmission time window (i.e., the reported information is associated with a certain time interval);
Per packet transmission;
Per group of packets (e.g., starting packet and number of packets).

Some embodiments may provide that the link adaptation state request message configures the user device to report one or more user-device manufacturing information elements.

According to some embodiments, the link adaptation state request message configures the user device to report one or more user device configuration information elements used for determining any of the link adaptation state information elements.

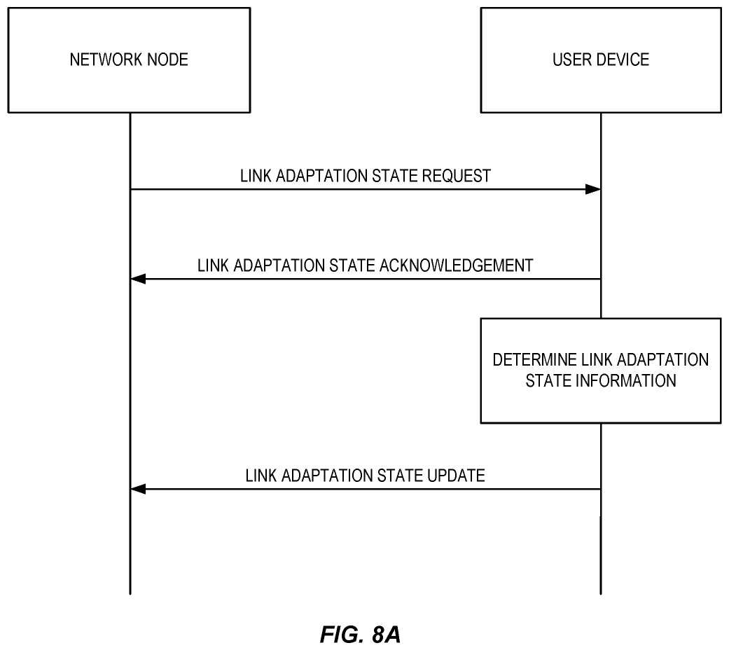

In one embodiment of the method, illustrated in FIGS. 8A and 8B, the network node may further receive a link adaptation state acknowledge message from the user device indicating a successful (or partial) initialization of a link adaptation state reporting procedure, or may receive a link adaptation state failure message from the user device indicating an unsuccessful initialization of a link adaptation state reporting procedure.

According to some embodiments, the network node determines one or more link adaptation parameter values based on a machine learning model/function and/or a machine learning algorithm. In one embodiment, a machine learning model/function or a machine learning algorithm determines a mapping from one or more information elements into an estimated or preferred value of at least one link adaptation parameter. Information elements used by the machine learning model/function or the machine learning algorithm may represent the state of the communication network, the state of the radio environment, the state of the network node, and combination thereof.

In some embodiments, a machine learning model/function used for determining one or more link adaptation parameter value may be one or more of the following:
A feedforward neural network;
A recurrent neural network;
A convolutional neural network;
An ensemble of neural networks, such as feedforward neural networks, recurrent neural networks, convolutional neural networks or a combination thereof;
A decision tree;
A decision forest;
A linear regression model;
A nonlinear regression model;
A learning graph.

According to some embodiments, a machine learning algorithm used for determining one or more link adaptation parameter value may be one or more of the following:
A multi-armed bandit;
A contextual multi-armed bandit;
A classifier;
A regression function followed by a selection function, such as an argmax( ) function, an argmin( ) function;
A reinforcement learning algorithm.

Computer implemented methods and systems are also disclosed herein that enable a user device in a telecommunication network to optimize the selection of radio resources and transmission format for a communication session with a network node. In some embodiments, the method comprises determining a link adaptation report for communicating with a network node, and transmitting a link adaptation state update message to a network node comprising one or more link adaptation state information associated with the communication link between the network node and the user device. The method is illustrated in FIG. 5.

In one embodiment of the method, illustrated in FIG. 7, the user device may further receive a link adaptation state request message from a network node configuring the user device for link adaptation reporting, and determine one or more link adaptation state information to be reported to the network node based on the link adaptation state request message. In one embodiment of the method, illustrated in FIGS. 8A and 8B, in response to a link adaptation state request message received from a network node, the user device may further determine whether the request of the network node can be fulfilled fully, in part, or not fulfilled, and transmit either a link adaptation state acknowledge message indicating a successful (or partial) initialization of a link adaptation state reporting procedure, or a link adaptation state failure message indicating an unsuccessful initialization of a link adaptation state reporting procedure. In particular, FIG. 8A illustrates a case of successful initialization of link adaptation reporting at the user device upon receiving link adaptation state request message from a network node. In this case, the user device may transmit a link adaptation state acknowledge message to indicating a successful initialization of a link adaptation reporting procedure, in case of a successful initialization, the user device may indicate that it fully or only partly acknowledges the configuration of the link adaptation reporting.

In one embodiment, in case of a partial successful initialization of the link adaptation reporting procedure, the link adaptation state acknowledgement message transmitted by the user device may additionally indicate the following:
A list of link adaptation information or parameters that can be reported;
The periodicity with which link adaptation reports can be transmitted to the network node;
The frequency domain granularity with which link adaptation information/parameters can be reported;
The time domain granularity with which link adaptation information/parameters can be reported;
A recommended granularity to use based on the user device experienced radio environment;
The spatial domain granularity with which link adaptation information/parameters can be reported.

FIG. 8B illustrates an embodiment of unsuccessful initialization of link adaptation state reporting at the user device upon receiving link adaptation state request message from a network node, in this case, the link adaptation state failure message may additionally indicate the cause of the initialization failure.

Some embodiments may provide that the user device determines one or more link adaptation parameter values based on a machine learning model/function and/or a machine learning algorithm. In one embodiment, a machine learning model/function or a machine learning algorithm determines a mapping from one or more information elements into an estimated or preferred value of at least one link adaptation parameter. Information elements used by the machine learning model/function or the machine learning algorithm may represent the state of the communication network, the state of the radio environment, the state of the user device, and combination thereof.

In some embodiments, a machine learning model/function used for determining one or more link adaptation parameter value may be one or more of the following:
A feedforward neural network;
A recurrent neural network;
A convolutional neural network;
An ensemble of neural networks, such as feedforward neural networks, recurrent neural networks, convolutional neural networks or a combination thereof;
A decision tree;
A decision forest;
A linear regression model;
A nonlinear regression model;
A learning graph.

According to some embodiments, a machine learning algorithm used for determining one or more link adaptation parameter value may be one or more of the following:
A multi-armed bandit;
A contextual multi-armed bandit;
A classifier;
A regression function followed by a selection function, such as an argmax( ) function, an argmin( ) function;
A reinforcement learning algorithm.

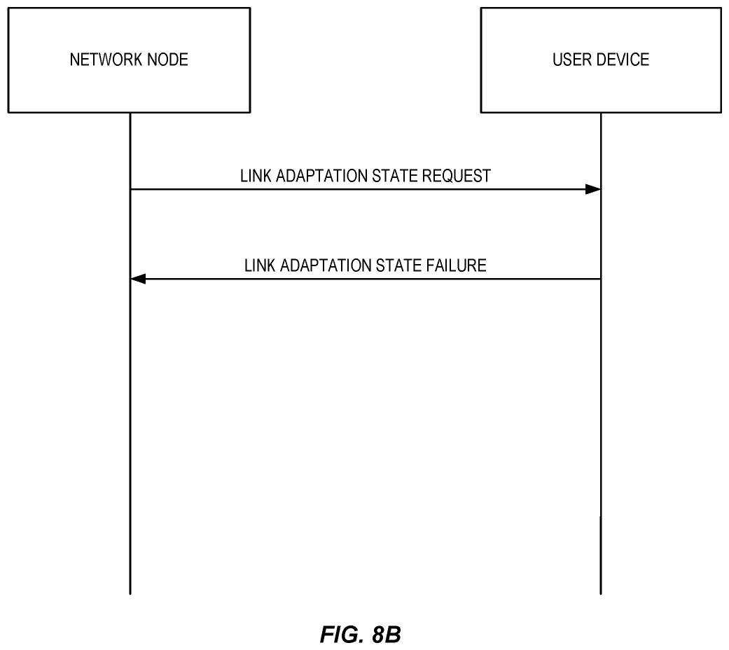

FIG. 9 provides a flowchart 900 illustrating exemplary operations of the network node for optimizing link adaptation for a communication session with a user device. In FIG. 9, operations begin with the network node receiving a link adaptation state update message from a user device, wherein the link adaptation state update message comprises one or more link adaptation state information elements associated with a communication link between the network node and the user device (block 902). The network node determines one or more link adaptation parameters for communicating with the user device based on the link adaptation state update message (block 904). Some embodiments may provide that the network node performs the operations of block 904 for determining the one or more link adaptation parameters based on ML (block 906). In some embodiments, the network node transmits a link adaptation state request message to the user device to configure or trigger a link adaptation state reporting from the user device (block 908). Some embodiments provide that the network node receives a link adaptation state acknowledge message from the user device indicating a successful or partially successful initialization of a link adaptation state reporting procedure (block 910). According to some embodiments, the network node receives a link adaptation state failure message from the user device indicating an unsuccessful initialization of a link adaptation state reporting procedure (block 912).

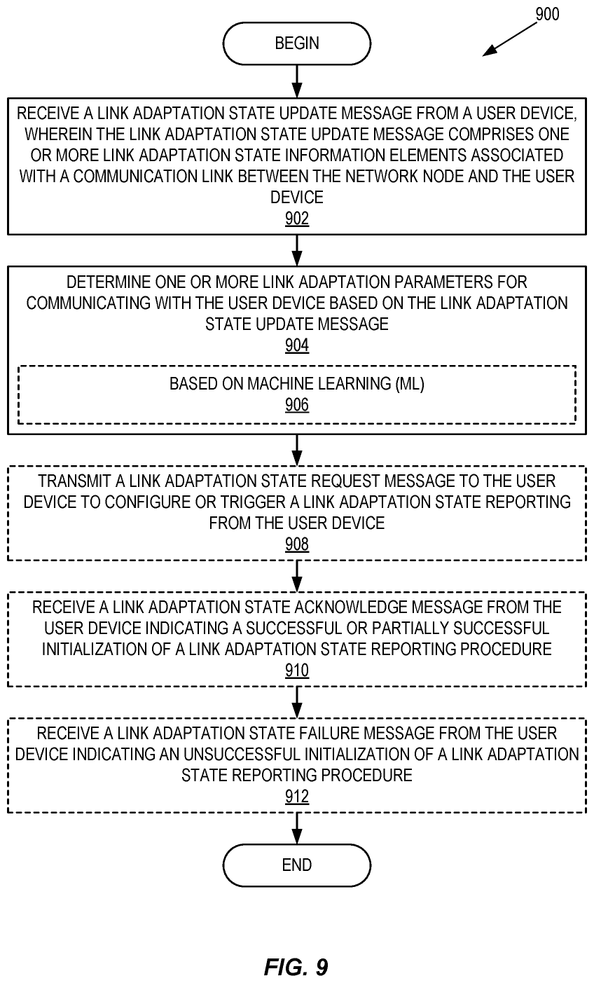

FIGS. 10A and 10B provide a flowchart 1000 illustrating exemplary operations of the user device to optimize the selection of radio resources and transmission format for a communication session with a network node. In FIG. 10A, operations begin with the use device determining a link adaptation report for communicating with the network node (block 1002). The user device transmits a link adaptation state update message to the network node, the link adaptation state update message comprising the link adaptation report comprising one or more link adaptation state information elements associated with a communication link between the network node and the user device (block 1004). In some embodiments, the user device receives a link adaptation state request message from the network node to configure the user device for link adaptation reporting (block 1006). The user device determines the one or more link adaptation state information elements to be reported to the network node based on the link adaptation state request message (block 1008). Operations in some embodiments continue at block 1010 of FIG. 10B.

Referring now to FIG. 10B, the user device, according to some embodiments, determines whether the request of the network node can be fulfilled fully or in part (block 1010). If so, the user device in some embodiments may determine one or more link adaptation parameter values based on machine learning (ML) (block 1012). The user device transmits a link adaptation state acknowledge message indicating a successful or partly successful initialization of a link adaptation state reporting procedure (block 1014). However, if the user device determines at decision block 1010 that the request of the network node cannot be fulfilled, the user device may transmit a link adaptation state acknowledge message indicating an unsuccessful initialization of a link adaptation state reporting procedure (block 1016).

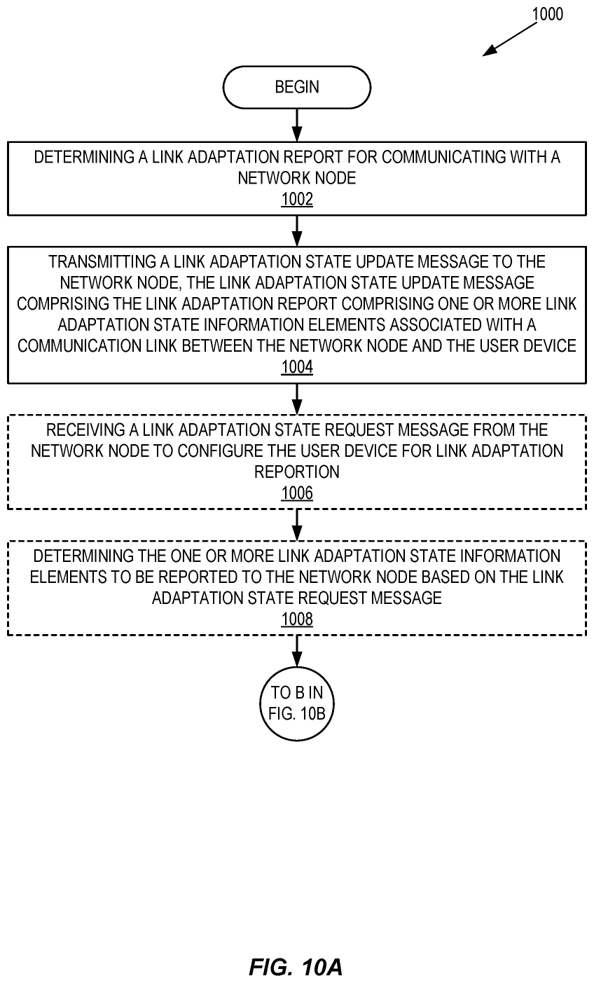

FIG. 11 is a schematic block diagram of a radio access node 1100 according to some embodiments of the present disclosure. Optional features are represented by dashed boxes. The radio access node 1100 may be, for example, a base station 202 or 206 or a network node that implements all or part of the functionality of the base station 202 or gNB described herein. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

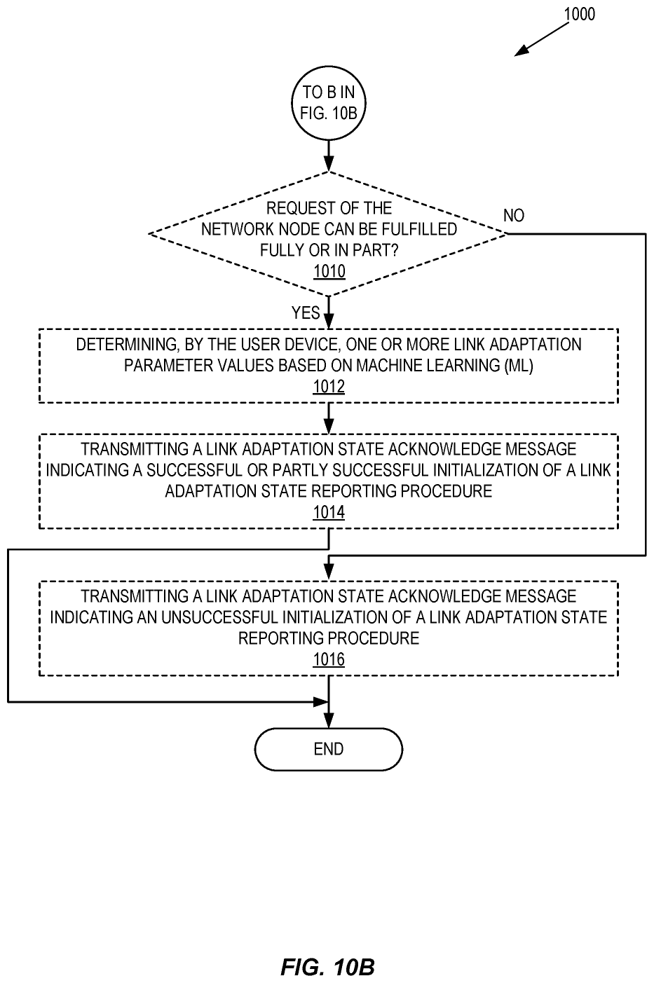

FIG. 12 is a schematic block diagram that illustrates a virtualized embodiment of the radio access node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 may include the control system 1102 and/or the one or more radio units 1110, as described above. The control system 1102 may be connected to the radio unit(s) 1110 via, for example, an optical cable or the like. The radio access node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the radio access node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

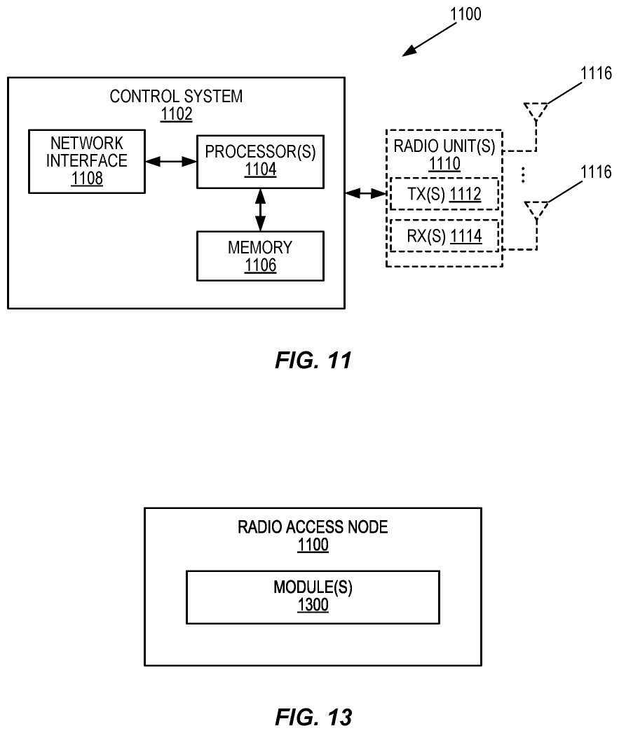

FIG. 13 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

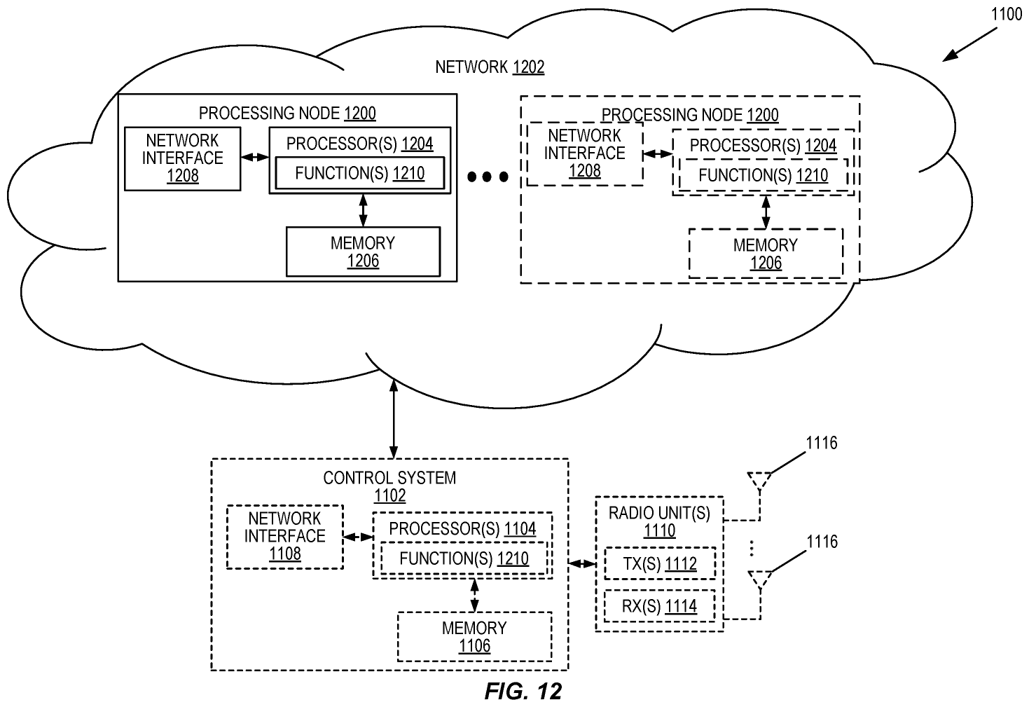

FIG. 14 is a schematic block diagram of a wireless communication device 1400 according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

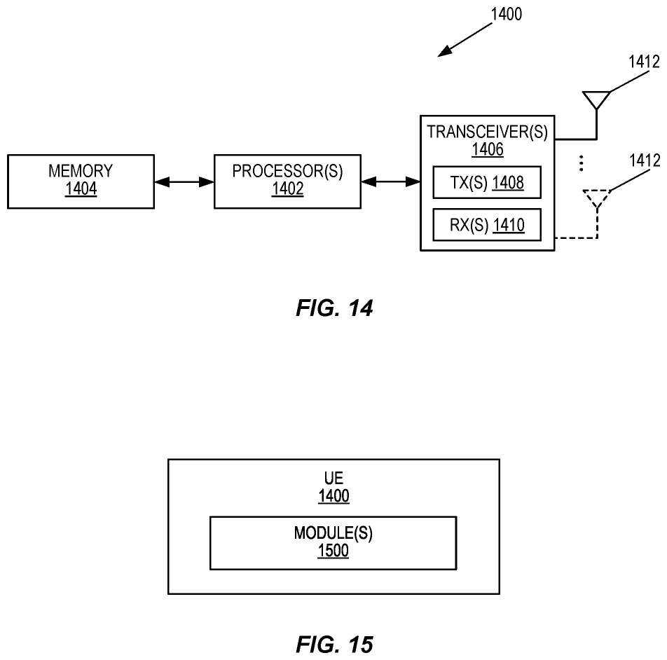

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., some embodiments may perform the operations in a different order, combine certain operations, overlap certain operations, etc.).

Some example embodiments of the present disclosure are as follows:

Embodiment 1: A method performed by a network node of a telecommunications network to optimize link adaptation for a communication session with a user device, the method comprising:
receiving a link adaptation state update message from a user device, wherein the link adaptation state update message comprises one or more link adaptation state information elements associated with a communication link between the network node and the user device; and
determining one or more link adaptation parameters for communicating with the user device based on the link adaptation state update message.

Embodiment 2: The method of embodiment 1, wherein the one or more link adaptation state information elements comprises a Channel State Information Measurement (CSI-M) report, wherein the CSI-M report comprises measurements of channel state associated with a coverage area of a radio cell and/or with different spatial areas of a radio cell.

Embodiment 3: The method of embodiment 2, wherein the measurements of channel state associated with different spatial areas are defined by one or more SSB beam coverage areas or one or more Channel State Information Reference Signal (CSI-RS) coverage areas.

Embodiment 4: The method of embodiment 2, wherein the CSI-M report comprises measurements of one or more of Channel Quality Indicator (CQI), rank, precoding matrix indicator (PMI), Signal-to-Noise ratio (SNR), and Signal-to-interference-plus-Noise ratio (SINR).

Embodiment 5: The method of embodiment 4, wherein the measurements are reported according to time and frequency granularity specified by one or more of wideband; per sub-band; per physical resource block (PRB); per resource block group (RBG); per transmission time window; or a combination of at least one time and at least one frequency reporting granularity.

Embodiment 6: The method of embodiment 2, wherein the one or more link adaptation state information elements further comprises an indication of an uncertainty measure for one or more information elements of the Channel State Information Measurement (CSI-M) report.

Embodiment 7: The method of embodiment 1, wherein the one or more link adaptation state information elements comprises a Channel State Information Prediction (CSI-P) report, wherein the CSI-P report comprises predictions of the channel state associated with a coverage area of a radio cell and/or with different spatial areas of a radio cell.

Embodiment 8: The method of embodiment 7, wherein the predictions of the channel state associated with different spatial areas are defined by one or more SSB beam coverage areas or one or more CSI-RS coverage areas.

Embodiment 9: The method of embodiment 7, wherein the CSI-P report comprises predictions of one or more of Channel Quality Indicator (CQI), rank, precoding matrix indicator (PMI), Signal-to-Noise ratio (SNR), and Signal-to-interference-plus-Noise ratio (SINR).

Embodiment 10: The method of embodiment 9, wherein the predictions are reported according to time and frequency granularity specified by one or more of wideband; per sub-band; per PRB; per RBG; per transmission time window; or a combination of at least one time and at least one frequency reporting granularity.

Embodiment 11: The method of embodiment 7, wherein the one or more link adaptation state information elements further comprises an indication of an uncertainty measure for one or more information elements of the Channel State Information Prediction (CSI-P) report.

Embodiment 12: The method of embodiment 1, wherein the one or more link adaptation state information elements comprises an indication of a mobility state of the user device, wherein the mobility state comprises one or more of velocity, acceleration, and type of mobility.

Embodiment 13: The method of embodiment 12, wherein the indication comprises a binary indicator configured to be set to a first value to indicate that the user device is static and a second value to indicate that the user device is moving with a speed above a specified threshold.

Embodiment 14: The method of embodiment 12, wherein the indication comprises a plurality of values each associated with a different velocity threshold.

Embodiment 15: The method of embodiment 1, wherein the one or more link adaptation state information elements comprises an indication of a channel fading state experienced by the user device.

Embodiment 16: The method of embodiment 15, wherein the indication comprises a fading indication that the user device is affected by shadow fading and/or fast fading.

Embodiment 17: The method of embodiment 1, wherein the one or more link adaptation state information elements comprises an indicator of a measured interference state experience by the user device.

Embodiment 18: The method of embodiment 17, wherein the indicator comprises one or more of measurements of a maximum or minimum peak interference measured over a set of time-frequency resource; a mean interference measured over a set of time-frequency resource; and a peak to average ratio of the interference measured over a set of time-frequency resources.

Embodiment 19: The method of embodiment 17, wherein the indicator is configured to be reported per wideband; per sub-band; per PRB; per RBG; per SSB beam coverage area; per CSI-RS beam coverage area; or a combination of at least one frequency and spatial granularity.

Embodiment 20: The method of embodiment 1, wherein the one or more link adaptation state information elements comprises an indicator of a predicted interference state experience by the user device.

Embodiment 21: The method of embodiment 20, wherein the indicator comprises one or more predictions of a peak interference predicted or estimated over a set of time-frequency resource; a mean interference predicted or estimated over a set of time-frequency resources; and a first and second statistical moments of interference predicted or estimated over a set of time-frequency resources.

Embodiment 22: The method of embodiment 20, wherein the indicator is configured to be reported per wideband; per sub-band; per PRB; per RBG; per SSB beam coverage area; per CSI-RS beam coverage area; or a combination of at least one frequency and spatial granularity.

Embodiment 23: The method of embodiment 1, wherein the one or more link adaptation state information elements comprises one or more measurements of a downlink data transmission state in at least a previous transmission time interval (TTI).

Embodiment 24: The method of embodiment 1, wherein the one or more link adaptation state information elements comprises one or more user-device manufacturing information elements.

Embodiment 25: The method of embodiment 24, wherein the one or more user-device manufacturing information elements comprises one or more of a user device model, a user device manufacturer, a user device receiver type, a user device receiver hardware, a user device chipset model, a user device chipset manufacturer, a user device processor type, a user device processor model, a user device operating system, and a user device antenna model.

Embodiment 26: The method of embodiment 1, wherein the one or more link adaptation state information elements comprises one or more user device configuration information elements used for determining any of the one or more link adaptation state information elements.

Embodiment 27: The method of embodiment 26, wherein the one or more user device configuration information elements comprises one or more of a type of algorithm, an algorithm configuration, an algorithm hyperparameter type and value, a type of filtering operation, and a filtering hyperparameter type and value.

Embodiment 28: The method of embodiment 1, further comprising transmitting a link adaptation state request message to the user device to configure or trigger a link adaptation state reporting from the user device.

Embodiment 29: The method of embodiment 28, wherein:
the link adaptation state request message comprises an indication of a type of reporting requested by the network node; and
the type of reporting comprises one or more of periodic reporting, aperiodic reporting, and event-triggered reporting.

Embodiment 30: The method of embodiment 29, wherein:
the type of reporting comprises periodic reporting; and
the link adaptation state request message further comprises one or more indications of a start time, a periodicity, and a duration of reporting.

Embodiment 31: The method of embodiment 29, wherein the type of reporting requested by the network node comprises comprise one or more indications to start, stop, pause, resume or modify the link adaptation state reporting for at least one type of link adaptation state information.

Embodiment 32: The method of embodiment 28, wherein the link adaptation state request message further comprises an indication of a type of link adaptation state information requested by the network node.

Embodiment 33: The method of embodiment 32, wherein the indication of the type of link adaptation state information requested by the network node comprises an indication of a Channel State Information Measurement (CSI-M) report.

Embodiment 34: The method of embodiment 32, wherein the indication of the type of link adaptation state information requested by the network node comprises an indication to report a Channel State Information Prediction (CSI-P) report.

Embodiment 35: The method of embodiment 32, wherein the indication of the type of link adaptation state information requested by the network node comprises an indication to report at least one uncertainty measure for one or more information elements of the Channel State Information Measurement (CSI-M) report.

Embodiment 36: The method of embodiment 32, wherein the indication of the type of link adaptation state information requested by the network node comprises an indication to report at least one uncertainty measure for one or more information elements of the Channel State Information Prediction (CSI-P) report.

Embodiment 37: The method of embodiment 32, wherein the indication of the type of link adaptation state information requested by the network node comprises an indication to report a user device mobility state.

Embodiment 38: The method of embodiment 32, wherein the indication of the type of link adaptation state information requested by the network node comprises an indication to report a channel fading state experience by the user device.

Embodiment 39: The method of embodiment 32, wherein the indication of the type of link adaptation state information requested by the network node comprises an indication to report a measured interference state experience by the user device.

Embodiment 40: The method of embodiment 32, wherein the indication of the type of link adaptation state information requested by the network node comprises an indication to report a predicted interference state experience by the user device.

Embodiment 41: The method of embodiment 32, wherein the indication of the type of link adaptation state information requested by the network node comprises an indication to report one or more measurements of the downlink data transmission state in at least a previous transmission time interval (TTI).

Embodiment 42: The method of embodiment 32, wherein the indication of the type of link adaptation state information comprises an indication to report one or more user-device manufacturing information elements.

Embodiment 43: The method of embodiment 32, wherein the indication of the type of link adaptation state information comprises an indication to report one or more user device configuration information elements used for determining any of the one or more link adaptation state information elements.

Embodiment 44: The method of any one of embodiments 32 to 43, wherein the link adaptation state request message further comprises, for each of the one or more link adaptation state information elements, an indication of one or more reporting granularities in a frequency domain, the one or more the reporting granularities comprising per wideband; per sub-band; per PRB; or per RBG reporting.

Embodiment 45: The method of any one of embodiments 32 to 43, wherein the link adaptation state request message further comprises, for each of the one or more link adaptation state information elements, an indication of one or more reporting granularities in a spatial domain, the one or more the reporting granularities comprising per SSB beam coverage area or per CSI-RS beam coverage area.

Embodiment 46: The method of any one of embodiments 32 to 43, wherein the link adaptation state request message further comprises, for each of the one or more link adaptation state information elements, an indication of one or more reporting granularities in a time domain, the one or more the reporting granularities comprising per TTI; per transmission time window; per packet transmission; or per group of packets.

Embodiment 47: The method of embodiment 1, further comprising receiving a link adaptation state acknowledge message from the user device indicating a successful or partially successful initialization of a link adaptation state reporting procedure.

Embodiment 48: The method of embodiment 1, further comprising receiving a link adaptation state failure message from the user device indicating an unsuccessful initialization of a link adaptation state reporting procedure. Embodiment 49: The method of embodiment 1, further comprising determining the one or more link adaptation parameter based on machine learning (ML).

Embodiment 50: A network node of a telecommunications network, adapted to:
receive a link adaptation state update message from a user device, wherein the link adaptation state update message comprises one or more link adaptation state information elements associated with a communication link between the network node and the user device; and
determine one or more link adaptation parameters for communicating with the user device based on the link adaptation state update message.

Embodiment 51: The network node of embodiment 50, further adapted to perform the method of any one of embodiments 2 to 49.

Embodiment 52: A network node, comprising
one or more transmitters;
one or more receivers; and
processing circuitry associated with the one or more transmitters and the one or more receivers, the processing circuitry configured to cause the network node to:
receive a link adaptation state update message from a user device, wherein the link adaptation state update message comprises one or more link adaptation state information elements associated with a communication link between the network node and the user device; and
determine one or more link adaptation parameters for communicating with the user device based on the link adaptation state update message.

Embodiment 53: The network node of embodiment 52, further adapted to perform the method of any one of embodiments 2 to 49.

Embodiment 54: A method performed by a user device in a telecommunications network to optimize selection of radio resources and transmission format for a communication session with a network node, the method comprising:
determining a link adaptation report for communicating with the network node; and
transmitting a link adaptation state update message to the network node, the link adaptation state update message comprising the link adaptation report comprising one or more link adaptation state information elements associated with a communication link between the network node and the user device.

Embodiment 55: The method of embodiment 54, further comprising:
receiving a link adaptation state request message from the network node to configure the user device for link adaptation reporting; and
determining the one or more link adaptation state information elements to be reported to the network node based on the link adaptation state request message.

Embodiment 56: The method of embodiment 55, further comprising, in response to the link adaptation state request message:
determining that the request of the network node can be fulfilled fully or in part; and
transmitting a link adaptation state acknowledge message indicating a successful or partly successful initialization of a link adaptation state reporting procedure.

Embodiment 57: The method of embodiment 56, wherein the link adaptation state acknowledge message comprises a list of link adaptation information or parameters that can be reported; a periodicity with which link adaptation reports can be transmitted to the network node; a frequency domain granularity with which link adaptation information or parameters can be reported; a time domain granularity with which link adaptation information or parameters can be reported; a recommended granularity to use based on the user device experienced radio environment; and a spatial domain granularity with which link adaptation information or parameters can be reported.

Embodiment 58: The method of embodiment 57, further comprising determining, by the user device, one or more link adaptation parameter values based on machine learning (ML).

Embodiment 59: The method of embodiment 55, further comprising, in response to the link adaptation state request message:
determining that the request of the network node cannot be fulfilled; and
transmitting a link adaptation state acknowledge message indicating an unsuccessful initialization of a link adaptation state reporting procedure.

Embodiment 60: A user device of a telecommunications network, adapted to:
determine a link adaptation report for communicating with a network node; and
transmit a link adaptation state update message to the network node, the link adaptation state update message comprising the link adaptation report comprising one or more link adaptation state information elements associated with a communication link between the network node and the user device.

Embodiment 61: The user device of embodiment 60, further adapted to perform the method of any one of embodiments 55 to 59.

Embodiment 62: A user device, comprising
one or more transmitters;
one or more receivers; and
processing circuitry associated with the one or more transmitters and the one or more receivers, the processing circuitry configured to cause the user device to:
determine a link adaptation report for communicating with a network node; and
transmit a link adaptation state update message to the network node, the link adaptation state update message comprising the link adaptation report comprising one or more link adaptation state information elements associated with a communication link between the network node and the user device.

Embodiment 63: The user device of embodiment 62, further adapted to perform the method of any one of embodiments 55 to 59.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMC Adaptive Modulation and Coding
AMF Access and Mobility Function
AN Access Network
AP Access Point
ASIC Application Specific Integrated Circuit
AUSF Authentication Server Function
BLER Block Error Rate
CPU Central Processing Unit
CQI Channel Quality Indicator
CSI Channel State Information
CSI-M Channel State Information Measurement
CSI-RS Channel State Information Reference Signal
CSI-P Channel State Information Prediction
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HARQ Hybrid Automatic Repeat Request
HSDPA High Speed Downlink Packet Access
HSS Home Subscriber Server
IoT Internet of Things
IP Internet Protocol
LTE Long Term Evolution
MCS Modulation and Coding Scheme
MIMO Multiple-Input Multiple Output
ML Machine Language
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
PMI Precoding Matrix Index
PRB Physical Resource Block
QoS Quality of Service
RAM Random Access Memory
RAN Radio Access Network
RBG Resource Block Group
RI Rank Indication
ROM Read Only Memory
RRH Remote Radio Head
RTT Round Trip Time
SCEF Service Capability Exposure Function
SINR Signal to Noise and Interference Ratio
SMF Session Management Function
SNR Signal to Noise Ratio
SSB Synchronization Signal Block
TDD Time-Division Duplex
TTI Transmission Time Interval
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a network node of a telecommunications network to optimize link adaptation for a communication session with a user device, the method comprising:
receiving a link adaptation state update message from a user device, wherein the link adaptation state update message comprises one or more link adaptation state information elements associated with a communication link between the network node and the user device; and
determining one or more link adaptation parameters for communicating with the user device based on the link adaptation state update message.

2. The method of claim 1, wherein:
the one or more link adaptation state information elements comprises a Channel State Information Measurement, CSI-M, report; and
the CSI-M report comprises measurements of channel state associated with a coverage area of a radio cell and/or with different spatial areas of a radio cell.

3. The method of claim 2, wherein the measurements of channel state associated with different spatial areas of the radio cell are defined by one or more Synchronization Signal Block, SSB, beam coverage areas or one or more Channel State Information Reference Signal, CSI-RS, coverage areas.

4. The method of claim 2, wherein the measurements of channel state comprise measurements of one or more of Channel Quality Indicator, CQI, rank; precoding matrix indicator, PMI; Signal-to-Noise ratio, SNR; or Signal-to-Interference-plus-Noise ratio, SINR.

5. The method of claim 4, wherein the measurements of channel state are reported according to time and/or frequency granularity specified by one or more of wideband; per sub-band; per physical resource block, PRB; per resource block group, RBG; per transmission time window; or a combination of at least one time reporting granularity and at least one frequency reporting granularity.

6. (canceled)

7. The method of claim 1, wherein:
the one or more link adaptation state information elements comprises a Channel State Information Prediction, CSI-P, report; and
the CSI-P report comprises one or more predictions or estimates of channel state associated with a coverage area of a radio cell and/or with different spatial areas of a radio cell.

8. The method of claim 7, wherein the one or more predictions or estimates of the channel state associated with different spatial areas of the radio cell are defined by one or more Synchronization Signal Block, SSB, beam coverage areas or one or more Channel State Information Reference Signal, CSI-RS, coverage areas.

9. The method of claim 7, wherein the CSI-P report comprises one or more predictions of one or more of Channel Quality Indicator, CQI, rank; precoding matrix indicator, PMI; Signal-to-Noise Ratio, SNR; and Signal-to-Interference-plus-Noise ratio, SINR.

10. The method of claim 9, wherein the one or more predictions are reported according to time and/or frequency granularity specified by one or more of wideband; per sub-band; per physical resource block, PRB; per resource block group, RBG; per transmission time window; or a combination of at least one time reporting granularity and at least one frequency reporting granularity.

11. (canceled)

12. The method of claim 1, wherein:
the one or more link adaptation state information elements comprises an indication of a mobility state of the user device, and the mobility state comprises one or more of velocity, acceleration, or type of mobility; or
the one or more link adaptation state information elements comprises an indication of a channel fading state experienced by the user device; or
the one or more link adaptation state information elements comprises an indicator of a measured interference state experience by the user device; or
the one or more link adaptation state information elements comprises an indicator of a predicted interference state experience by the user device; or
the one or more link adaptation state information elements comprises one or more measurements of a downlink data transmission state in at least a previous transmission time interval, TTI; or
the one or more link adaptation state information elements comprises one or more user-device manufacturing information elements; or
the one or more link adaptation state information elements comprises one or more user device configuration information elements used for determining any of the one or more link adaptation state information elements.

13-27. (canceled)

28. The method of claim 1, further comprising transmitting a link adaptation state request message to the user device to configure or trigger a link adaptation state reporting from the user device.

29. The method of claim 28, wherein:
the link adaptation state request message comprises an indication of a type of reporting requested by the network node; and
the type of reporting comprises one or more of periodic reporting, aperiodic reporting, or event-triggered reporting.

30. The method of claim 29, wherein:
the type of reporting comprises periodic reporting; and
the link adaptation state request message further comprises one or more indications of a start time, a periodicity, or a duration of reporting.

31. The method of claim 29, wherein the type of reporting requested by the network node comprises one or more indications to start, stop, pause, resume or modify the link adaptation state reporting for at least one type of link adaptation state information.

32. The method of claim 28, wherein the link adaptation state request message further comprises an indication of a type of link adaptation state information requested by the network node.

33. The method of claim 32, wherein the indication of the type of link adaptation state information requested by the network node comprises;
an indication of a Channel State Information Measurement, CSI-M, report; or
an indication to report a Channel State Information Prediction, CSI-P, report; or
an indication to report at least one uncertainty measure for one or more information elements of a Channel State Information Measurement, CSI-M, report; or
comprises an indication to report at least one uncertainty measure for one or more information elements of a Channel State Information Prediction, CSI-P, report; or
an indication to report a user device mobility state; or
an indication to report a channel fading state experience by the user device; or
an indication to report a measured interference state experienced by the user device; or
an indication to report a predicted interference state experienced by the user device; or
comprises an indication to report one or more measurements of a downlink data transmission state in at least a previous transmission time interval, TTI; or
an indication to report one or more user-device manufacturing information elements; or
an indication to report one or more user device configuration information elements used for determining any of the one or more link adaptation state information elements.

34-43. (canceled)

44. The method of claim 32, wherein the link adaptation state request message further comprises, for each of the one or more link adaptation state information elements:
an indication of one or more reporting granularities in a frequency domain, the one or more the reporting granularities comprising per wideband; per sub-band; per physical resource block, PRB; or per resource block group, RBG, reporting; or
an indication of one or more reporting granularities in a spatial domain, the one or more the reporting granularities comprising per Synchronization Signal Block, SSB, beam coverage areas or per Channel State Information Reference Signal, CSI-RS, beam coverage area; or
an indication of one or more reporting granularities in a time domain, the one or more the reporting granularities comprising per TTI; per transmission time window; per packet transmission; or per group of packets.

45-51. (canceled)

52. A network node, comprising:
one or more transmitters;
one or more receivers; and
processing circuitry associated with the one or more transmitters and the one or more receivers, the processing circuitry configured to cause the network node to:
receive a link adaptation state update message from a user device, wherein the link adaptation state update message comprises one or more link adaptation state information elements associated with a communication link between the network node and the user device; and
determine one or more link adaptation parameters for communicating with the user device based on the link adaptation state update message.

53. (canceled)

54. A method performed by a user device in a telecommunications network to optimize selection of radio resources and transmission format for a communication session with a network node, the method comprising:
determining a link adaptation report for communicating with the network node; and
transmitting a link adaptation state update message to the network node, the link adaptation state update message comprising the link adaptation report comprising one or more link adaptation state information elements associated with a communication link between the network node and the user device.

55. The method of claim 54, further comprising:
receiving a link adaptation state request message indicating a request of the network node to configure the user device for link adaptation reporting; and
determining the one or more link adaptation state information elements to be reported to the network node based on the link adaptation state request message.

56. The method of claim 55, further comprising, in response to the link adaptation state request message:
determining that the request of the network node can be fulfilled fully or in part; and
transmitting a link adaptation state acknowledge message indicating a successful or partly successful initialization of a link adaptation state reporting procedure.

57. The method of claim 56, wherein the link adaptation state acknowledge message comprises a list of link adaptation information or parameters that can be reported; a periodicity with which link adaptation reports can be transmitted to the network node; a frequency domain granularity with which link adaptation information or parameters can be reported; a time domain granularity with which link adaptation information or parameters can be reported; a recommended granularity to use based on a user-device-experienced radio environment; and a spatial domain granularity with which link adaptation information or parameters can be reported.

58-61. (canceled)

62. A user device, comprising
one or more transmitters;
one or more receivers; and
processing circuitry associated with the one or more transmitters and the one or more receivers, the processing circuitry configured to cause the user device to:
determine a link adaptation report for communicating with a network node; and
transmit a link adaptation state update message to the network node, the link adaptation state update message comprising the link adaptation report comprising one or more link adaptation state information elements associated with a communication link between the network node and the user device.

63. (canceled)
